(19) United States
(12) Patent Application Publication
(10) Pub. No.: US 2020/0152963 A1
(43) Pub. Date: May 14, 2020

(54) Anode Material of Lithium Ion Battery And Non-aqueous Electrolyte Battery

(71) Applicant: AAC Acoustic Technologies (Shenzhen) Co., Ltd., Shenzhen (CN)

(72) Inventors: Jian Zhang, Shenzhen (CN); Xiaoming Lou, Shenzhen (CN); Qianjin Zhao, Shenzhen (CN); Shaohai Chen, Saratoga, CA (US)

(21) Appl. No.: 16/679,332

(22) Filed: Nov. 11, 2019

(30) Foreign Application Priority Data
Nov. 13, 2018 (CN) 201811346550.3

(51) Int. Cl. H01M 4/131; H01M 10/0525; H01M 4/1391

(52) U.S. Cl. CPC H01M 4/131; H01M 2004/027; H01M 4/1391; H01M 10/0525

(57) ABSTRACT

An anode material of a lithium-ion battery according to the present invention is disclosed. A chemical formula of the anode material of the lithium-ion battery is MₓNb_{y}O_{z}, wherein, M is a pentavalent non-niobium metal ion or a hexavalent non-niobium metal ion, and x, y, z satisfy the following conditions: 1<x≤16, 2≤y≤28, and 13≤z≤94.

The present disclosure relates to lithium ion battery field, more particularly to an anode material of lithium ion battery and a non-aqueous electrolyte battery.

### DESCRIPTION OF RELATED ART

Lithium-ion batteries with high power density and energy density have been recognized as a promising energy source for electrical vehicles. Recently, the fast-growing market of electrical vehicles has led to increasing demands for the development of high performance lithium-ion batteries, and the key to improve the battery performance is to develop new electrode materials. At present, commercial lithium-ion batteries use graphite as an anode material and a liquid organic solution as an electrolyte. Graphite has the advantages of high theoretical capacity (372 mAh g⁻¹), long cycle life, low cost, etc. However, at high rate charging/discharging process, the battery could face short-circuiting, even worse burns due to the formation of lithium dendrite, because of the low operating potential of graphite anode. In addition, the low lithium ion diffusion coefficient of graphite hinders their application in high performance lithium ion batteries. Due to the small diffusion coefficient, high overpotential will be observed during the fast charging process with large current density, resulting in more negative potential of graphite anode, which will increase the tendency to generate lithium dendrites and introduce the safety issue. At the same time, under the condition of large current charging, the heat generated by the system is intensified, resulting in easier decomposition of the traditional liquid organic electrolyte. In Therefore, it has been an urgent need to develop an anode material having excellent electrochemical performance and high safety performance.

Among the anode materials which are promising to replace graphite, the “zero strain” Li₄Ti₅O₁₂ material has been extensively studied. The material has a safe working potential, good cycle performance, and after modification the Li₄Ti₅O₁₂ material t can meet the requirements of fast charging, but its inherent low theoretical capacity (only 175 mAhg⁻¹) limits the application in high performance lithium ion batteries.

Under such conditions, the M-Nb—O anode material has attracted attention because of its high theoretical capacity and safe operating potential. Compared with the Li₄Ti₅O₁₂ material, the M-Nb—O material also has a safe working potential (Nb³⁺/Nb⁴⁺ and Nb⁴⁺/Nb⁵⁺), but since there are two electrons transfer between Nb³⁺ and Nb⁵⁺, the M-Nb—O material has a higher theoretical capacity. In addition, the M-Nb—O material has a more open spatial structure than the Li₄Ti₅O₁₂ structure, which is more conducive to the conduction of ions and electrons. Therefore, the M-Nb—O material has better electrochemical performance. However, only a small amount of M-Nb—O material has been used for non-aqueous electrolyte batteries so far. Therefore, exploring more M-Nb—O anode materials with good electrochemical properties is very helpful for the development of high performance non-aqueous electrolyte batteries.

### BRIEF DESCRIPTION OF THE DRAWINGS

FIG. 1 shows a crystal structure of a shearing ReO₃ of W₃Nb₁₄O₄₄;

FIG. 2 shows a crystal structure of a tungsten bronze of Mo₁₆Nb₁₈O₉₃;

FIG. 3 shows X-ray diffraction pattern of MoNb₁₂O₃₃ having shearing ReO₃ structure produced in embodiment 1 of the present invention;

FIG. 4 shows X-ray diffraction pattern of W₄Nb₂₆O₇₇ having shearing ReO₃ structure produced in embodiment 2 of the present invention;

FIG. 5 shows X-ray diffraction patterns of WNb₁₂O₃₃ having shearing ReO₃ structure produced in embodiment 3 of the present invention;

FIG. 6 shows X-ray diffraction pattern of Mo₃Nb₁₄O₄₄ having shearing ReO₃ structure produced in embodiment 4 of the present invention;

FIG. 7 shows X-ray diffraction pattern of W₁₈Nb₁₆O₉₄ having stungsten bronze structure produced in embodiment 5 of the present invention;

FIG. 8 shows X-ray diffraction patterns of W₃Nb₁₄O₄₄ having shearing ReO₃ structure produced in embodiment 6 of the present invention;

FIG. 9 shows X-ray diffraction patterns of Mo₄Nb₂₆O₇₇ having shearing ReO₃ structure produced in embodiment 7 of the present invention;

FIG. 10 shows X-ray diffraction patterns of Mo₁₆Nb₁₈O₉₃ having stungsten bronze structure produced in embodiment 19 of the present invention;

FIG. 11 shows a rate performance of MoNb₁₂O₃₃ half-cell produced in embodiment 80 of the present invention;

FIG. 12 shows a rate performance of MoNb₁₂O₃₃ half-cell produced in embodiment 81 of the present invention;

FIG. 13 shows a rate performance of W₃Nb₁₄O₄₄ half-cell produced in embodiment 82 of the present invention;

FIG. 14 shows a rate performance of W₃Nb₂O₁₄ half-cell produced in embodiment 83 of the present invention;

FIG. 15 shows cycle performance of MoNb₁₂O₃₃ half-cell produced in embodiment 80 and embodiment 81 of the present invention;

FIG. 16 shows a cycle performance of W₃Nb₁₄O₄₄ half-cell produced in embodiment 82 of the present invention;

FIG. 17 shows a cycle performance of W₃Nb₂O₁₄ half-cell produced in embodiment 83 of the present invention;

FIG. 18 shows a rate performance of WNb₁₂O₃₃/LiMn₂O₄ solid state battery produced in embodiment 84 of the present invention;

FIG. 19 shows a rate performance of Mo₃Nb₁₄O₄₄/LiMn₂O₄ solid state battery produced in embodiment 85 of the present invention;

FIG. 20 shows a rate performance of W₄Nb₂₆O₇₇/LiMn₂O₄ solid state battery produced in embodiment 86 of the present invention;

FIG. 21 shows a cycle performance of WNb₁₂O₃₃/LiMn₂O₄ solid state battery produced in embodiment 84 of the present invention;

FIG. 22 shows a cycle performance of Mo₃Nb₁₄O₄₄/LiMn₂O₄ solid state battery produced in embodiment 85 of the present invention;

FIG. 23 shows a cycle performance of W₄Nb₂₆O₇₇/LiMn₂O₄ solid state battery produced in embodiment 86 of the present invention.

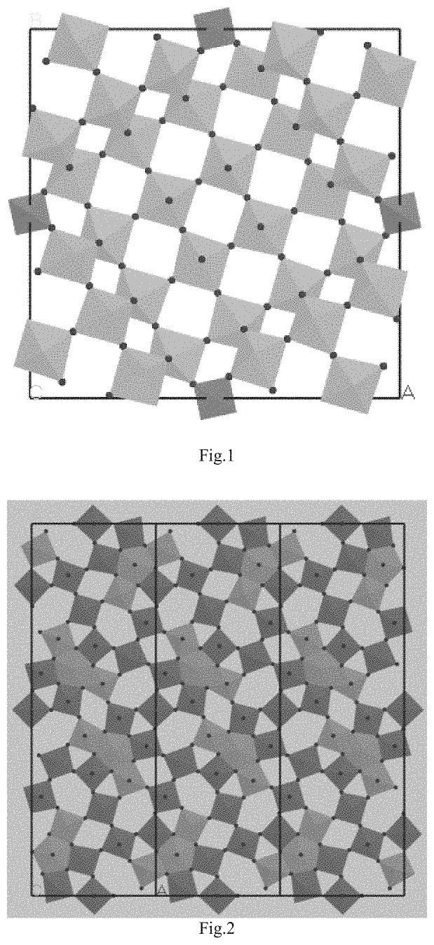

### DETAILED DESCRIPTION OF THE EXEMPLARY EMBODIMENTS

In order to clearly explain the object, technical solution and advantages of the present invention, the embodiments will be described detailly in conjunction with the figures of the present invention. It is evident that the described embodiments are merely part of the embodiments of the present invention, rather than all of the embodiments. Basing on the embodiments of the present invention, all other embodiments obtained by a person of ordinary skill in the art without applying inventive activity are all within the scope of protection of the present invention.

Hereafter, the present disclosure will be further described with reference to the accompanying drawings and embodiment. If there is no special definition for the raw material used in the preparing method, the raw material can be purchased from the market.

An anode material of a lithium-ion battery according to the present invention is disclosed. A chemical formula of the anode material of the lithium-ion battery is MₓNb_{y}O_{z}, wherein, M is a pentavalent non-niobium metal ion and/or a hexavalent non-niobium metal ion, and x, y, z satisfy the following conditions: 1<x≤16, 2≤y≤28, and 13≤z≤94.

M may be one or more elements selected from V, Bi, W, Mo, Cr, Mn and Fe.

MₓNb_{y}O_{z} may be one or more compounds selected from MNb₉O₂₅, M₃Nb₁₄O₄₄, MNb₁₂O₃₃, M₄Nb₂₆O₇₇, M₅Nb₁₆O₅₅, MsNb₁₈O₆₉, MNb₄O₁₃, M₁₆Nb₁₈O₉₃, M₇Nb₄O₃₁ and M₉Nb₈O₄₇.

A crystal structure of MₓNb_{y}O_{z} includes a shearing ReO₃ structure and a tungsten bronze structure. MₓNb_{y}O_{z} having the shearing ReO₃ structure includes M₃Nb₁₄O₄₄, MNb₁₂O₃₃, M₄Nb₂₆O₇₇, M₅Nb₁₆O₅₅, M₈Nb₁₈O₆₉; MₓNb_{y}O_{z} having the tungsten bronze structure includes MNb₄O₁₃, M₁₆Nb₁₈O₉₃, M₇Nb₄O₃₁, M₉Nb₈O₄₇.

The shearing ReO₃ structure or the tungsten bronze structure is composed of by one or more structure units selected from MeO₆ octahedral structure unit, MeO₄ tetrahedral structure unit. Me includes Nb ion or non-niobium metal ion. The structure of MₓNb_{y}O_{z} is made by the octahedral structure unit and/or the tetrahedral structure unit connected with each other by common dot connection, common edge connection or common surface connection or their combination. MₓNb_{y}O_{z} may be one or more compounds selected from the group of W₃Nb₁₄O₄₄, WNb₁₂O₃₃, W₄Nb₂₆O₇₇, W₅Nb₁₆O₅₅, W₈Nb₁₈O₆₉, WNb₄O₁₃, W₁₆Nb₁₈O₉₃, W₇Nb₄O₃₁, W₉Nb₈O₄₇, Mo₃Nb₁₄O₄₄, MoNb₂O₃₃, Mo₄Nb₂₆O₇₇, Mo₅Nb₁₆O₅₅, Mo₈Nb₁₈O₆₉, MoNb₄O₁₃, Mo₁₆Nb₁₈O₉₃, Mo₇Nb₄O₃₁, Mo₉Nb₈O₄₇, Cr₃Nb₁₄O₄₄, CrNb₁₂O₃₃, Cr₄Nb₂₆O₇₇, Cr₅Nb₁₆O₅₅, Cr₈Nb₈O₆₉, CrNb₄O₁₃, Mo₁₆Nb₁₈O₉₃, Cr₇Nb₄O₃₁, Cr₉Nb₈O₄₇, VNb₉O₂₅ and BiNb₉O₂₅.

Compared with traditional graphite anode, the MₓNb_{y}O_{z} anode material of lithium-ion battery has high theoretical specific capacity, high safety, high reversible specific capacity, high coulomb efficiency, and excellent cycle performance, and so on. The MₓNb_{y}O_{z} anode material can improve the charge rate performance of the lithium-ion battery, and can solve many problems occurred while charging the lithium battery using liquid electrolyte and graphite anode material, such as unstable liquid electrolyte, many lithium dendrites. Especially, the anode material MₓNb_{y}O_{z} can be used as a new electrode material of non-aqueous electrolyte battery to solve the matter that prevent high performance non-aqueous electrolyte battery from developing due to lack of M-Nb—O material. For embodiment, the M-Nb—O is applied into the solid lithium ion battery, since the MₓNb_{y}O_{z} material has low charge-discharge expansion ratio, reduced interface impedance, the electrochemical performance thereof applied into the lithium battery is enhanced.

The present invention provides several methods for manufacturing the MₓNb_{y}O_{z} anode material, comprising a solid phase method, a solution method, and a solvent-thermal method.

The solid phase method comprises the following steps: mixing a metal M source and a niobium source at a molar ratio of M:Nb=x:y, and then milling the mixture by high energy ball milling and sintering it at high temperature to obtain MₓNb_{y}O_{z} powder. The sintering temperature is ranged from 700° C. to 1300° C., the sintering time is ranged from 4 h to 14 h.

Preferably, the metal M source comprises M oxide and/or M salt. The M salt comprises M acetylacetone and/or M acetate. The niobium source may be one or more type selected from the group of niobium pentoxide, niobium powder, niobium oxalate, niobium ethoxide.

The solution method comprise the following steps:

Step1: mixing Nb precursor organic solution, an acidic solution with concentration of hydrogen ion of 0.1-3 mol/L, and a surfactant, to form a reaction solution;

Step2: mixing a M precursor with the reaction solution, after stirring and reacting for 4-6 h, then drying to obtain a solid product; the M precursor is mixed at molar ratio M:Nb=x:y, wherein, the molar ratio of M in the M precursor solution, the molar ratio of Nb in the Nb precursor organic solution,

Step 3: treating the solid product at a temperature of 800-1300° C. for 4-10 h to obtain MₓNb_{y}O_{z} composite oxide.

Preferably, the metal M source comprises M oxide and/or M salt. The M salt comprises M acetylacetone and/or M acetate. The niobium source may be one or more type selected from niobium pentoxide, niobium powder, niobium oxalate, niobium ethoxide; the surfactant may be one or more compounds selected from the group of sodium dodecyl sulfate, calcium dodecylben-zenesulfonate, 1-hexadecylamine, and hexadecyl trimethyl ammonium bromide.

The solvent-thermal method comprises the following steps:

dissolving metal M source and Nb source at a molar ratio of M:Nb=x:y into an organic solution of 60-80 mL, stirring the solution with magnetic force for 6-10 h, then adding the solution into a polytetrafluoroethylene liner of a reactor, and then heating the solution for 24 h to obtain a product. Washing the product using ethanol or water. Centrifugal treating and drying the product to obtain a precursor powder, then sintering the precursor powder to obtain MₓNb_{y}O_{z} powder.

Preferably, the metal M source comprises M salt. The M salt may be one or more compounds selected from M acetylacetone, M chloride and M acetate. The niobium source may be one or more type of niobium powder, niobium oxalate, niobium ethoxide. The organic solvent comprises N, n-dimethylformamide or/and ethanol.

The heating temperature is 200° C., the sintering temperature is ranged from 650° C. to 900° C., sintering time is ranged from 3 h to 5 h.

A non-aqueous electrolyte lithium-ion battery is provided in the present invention. The battery comprises a positive electrode material, non-aqueous electrolyte, a diaphragm and the anode material as above mentioned.

The non-aqueous electrolyte lithium-ion battery comprises a liquid state non-aqueous electrolyte lithium-ion battery, a gel state non-aqueous electrolyte lithium-ion battery, and/or a solid state non-aqueous electrolyte lithium-ion battery.

The positive electrode material is one or more compounds selected from oxide, sulfide and polymer. Specifically, the oxide comprise one or more type of Li—Mn-oxide, Li—Ni-oxide, Li—Co-oxide, Li—Ni—Co-oxide, Li—Mn—Ni-oxide, Li—Mn—Co-oxide, Li-phosphorylation and Li—Ni—Co—Mn-oxide. The sulfide comprises sulfation product. The polymer comprises at least one of polyaniline, polypyrole, and disulfide-based polymer.

The non-aqueous electrolyte of the non-aqueous electrolyte battery comprises one or more type of a liquid state non-aqueous electrolyte, a gel state non-aqueous electrolyte, and a solid state non-aqueous electrolyte. Specifically, the electrolyte may be one or more compounds selected from the group of lithium perchlorate, lithium perchlorate, lithium tetrafluoroborate, lithium hexafluoroarsenate, lithium trifluoromethanesulfonate, bis(trifluoromethane)sulfonimide lithium.

The solid state non-aqueous electrolyte battery is manufactured by the following steps:

mixing the anode material, solid state electrolyte, and conductive carbon black at a mass weight ratio of 60:35:5 to form an anode mixture powder;

mixing the positive electrode material, solid state electrolyte, and conductive carbon black at a mass weight ratio of 60:35:5 to form an positive electrode mixture powder;

the positive electrode mixture powder, solid state, and the anode mixture powder arranged as layers in orderly, rolling to form a sandwiched structure;

connecting the anode and positive electrode of the sandwiched structure with the current collector to form the solid state lithium-ion battery.

The method is operated under protective air. The sandwiched structure is rolled under a pressure of 500-700 MPa, the thickness of the positive electrode and the anode is about 300 μm, a diameter thereof is about 12 mm; and connected with the stainless steel current collector to form the solid state lithium-ion battery.

The solid state non-aqueous electrolyte comprises a sulfide based solid state non-aqueous electrolyte, an oxide-based solid state non-aqueous electrolyte, and conductive polymer non-aqueous electrolyte. The sulfide based solid state non-aqueous electrolyte comprises Li₂S-A, halogen doped Li₂S-A, Li₂S-MeS₂—P₂S₅, and halogen doped Li₂S-MeS₂—P₂S₅. A is one or more type selected from the group of P₂S₅, SiS₂, GeS₂, B₂S₃ and Al₂S₄, Me is one or more elements selected from the group of Si, Ge, Sn, and Al. Halogen is one or more element selected from Cl, Br and I. Preferably, Li_{9.54}Si_{1.74}P_{1.44}S_{11.7}Cl_{0.3}. The oxide-based solid state non-aqueous electrolyte are crystalline and amorphous. The crystalline oxide-based solid state non-aqueous electrolyte comprises perovskite type, NASICON type, LISICON type, garnet type, and so on. Garnet type Li_{6.5}La₃Zr_{1.75}Te_{0.25}O₁₂ electrolyte is preferable one. The amorphous electrolyte comprises LiPON electrolyte. The conductive polymer solid state electrolyte comprises polyethylene oxide, polyacrylonitrile, polyvinylidene fluoride, polymethyl methacrylate, poly[oxy(methyl-1,2-ethanediyl)], polyvinylidene chloride, or single ion polymer.

The battery may comprises an anode, a positive electrode, a non-aqueous electrolyte, a diaphragm, and a package.

The anode comprises current collector, anode material, electric conductive agent and binder; the current collector includes copper, nickel, stainless steel, aluminum, or an aluminum alloy containing another metal. The anode material is at least one compound selected from MₓNb_{y}O_{z} material, graphite, lithium metal and lithium titanate. The electric conductive agent is at least one type selected from carbon black, graphite, and acetylene black. The binder is at least one compound selected from polytetrafluoroethylene, polyvinylidene fluoride, fluorine-based rubber. In the anode of the non-aqueous electrolyte battery, the mass weight percent of anode material is more than 65%, and the mass weight percent of electric conductive agent is more than 2%.

The positive electrode comprises a current collector, a positive electrode material, electric conductive agent and binder. The current collector comprises aluminum, or an aluminum alloy containing another metal. The positive electrode material is one or more compound selected from oxide, sulfide and polymer. Specifically, the oxide comprise one or more type of Li—Mn-oxide (such as Li_{X}Mn₂O₄), Li—Ni-oxide (such as LiNi₂O₄), Li—Co-oxide (such as LiₐCoO₂), Li—Ni—Co-Oxide (such as LiNi_{1-b}CO_{b}O₂), Li—Mn—Ni-oxide (such as LiMn_{2-b}Ni_{b}O₂, LiMn_{2-b}Ni_{b}O₄), Li—Mn—Co-oxide (such as LiₐMn_{b}CO_{1-b}O₂), Li-phosphorylation (such as LiₐFePO₄, LiₐMPO₄, Li₂MPO₄F) and Li—Ni—Co—Mn-oxide. In the chemical formula of the oxide, a, b satisfy the following conditions: 0≤a≤1, 0≤b≤1. The sulfide comprises sulfation product (such as Fe₂(SO₄)₃). The polymer comprises at least one of polyaniline, polypyrole, and disulfide-based polymer. The electric conductive agent comprises at least one of carbon black, graphite, and acetylene black. The binder is at least one compound selected from polytetrafluoroethylene, polyvinylidene fluoride, fluorine-based rubber. In the positive electrode of the non-aqueous electrolyte battery, the mass weight percent of positive electrode material is more than 65%, and the mass weight percent of electric conductive agent is more than 2%.

The non-aqueous electrolyte of the non-aqueous electrolyte battery comprises one or more type of a liquid state non-aqueous electrolyte, a gel state non-aqueous electrolyte, and a solid state non-aqueous electrolyte. The liquid state non-aqueous electrolyte is prepared by dissolving the electrolyte into the organic solvent. The gel state non-aqueous electrolyte is prepared by forming the liquid state electrolyte and polymer complex. Specifically, the electrolyte comprises lithium salt and their mixture, which comprises lithium perchlorate, lithium perchlorate, lithium tetrafluoroborate, lithium hexafluoroarsenate, lithium trifluoromethanesulfonate, bistrifluoromethanesulfonimide lithium. The organic solvent comprises cyclic carbonate, linear carbonate, cycle ethers, linear ethers, acetonitrile, sulfolane. The cyclic carbonate comprises diethyl carbonate, dimethyl carbonate, or dimethyl ethyl carbonate. The cycle ethers comprises tetrahydrofuran, 2-methyltetrahydrofuran, or 1,4-dioxane. The linear ethers comprises dimethylethane or diethoxyethane.

The solid state non-aqueous electrolyte comprises a sulfide based solid state non-aqueous electrolyte, an oxide-based solid state non-aqueous electrolyte, and conductive polymer non-aqueous electrolyte. The sulfide based solid state non-aqueous electrolyte comprises a binary sulfide Li₂S-A, such as Li₂S—P₂S₅, Li₂S—SiS₂, Li₂S—GeS₂, Li₂S—B₂S₃, Al₂S₄, a ternary sulfide Li₂S-MeS₂—P₂S₅(Me=Si, Ge, Sn, and/or Al), or halogen doped binary sulfide Li₂S-A(A=P₂S₅, SiS₂, GeS₂, P₂S₅, B₂S₃ and/or Al₂S₄), a halogen doped ternary sulfide Li₂S-MeS₂—P₂S₅(Me=Si, Ge, Sn, and/or Al). Halogen is one or more element selected from Cl, Br and I. Preferably, Li_{9.54}Si_{1.74}P_{1.44}S_{11.7}Cl_{0.3}. The oxide-based solid state non-aqueous electrolyte are crystalline and amorphous. The crystalline oxide-based solid state non-aqueous electrolyte comprises perovskite type, NASICON type, LISICON type, garnet type, preferably, garnet type Li_{6.5}La₃Zr_{1.75}Te_{0.25}O₁₂ electrolyte. The amorphous electrolyte comprises LiPON electrolyte. The conductive polymer solid state electrolyte comprises polyethylene oxide, polyacrylonitrile, vinylidene fluoride, polymethyl methacrylate, poly[oxy(methyl-1,2-ethanediyl)], polyvinylidene chloride, or single ion polymer.

The diaphragm comprises porous membrane, which is consisting of polyethylene, polypropylene, cellulose, or polyvinylidene fluoride.

The package may be cylinder shape, square shape, and button shape. The shape can be designed depending on the actual requirements so that it can be used in mobile device or electric vehicle.

Existing anode materials of solid state lithium-ion battery mostly use metal lithium and lithium titanate, the expansion ratio of charge-discharge volume of metal lithium is large, and the theoretical capacity of lithium titanate is low. The present invention firstly applies an MₓNb_{y}O_{z} material as a negative electrode material to a non-aqueous electrolyte lithium. In ion batteries, especially solid state lithium-ion batteries, the cycle stability of the battery is obviously improved, and the pressure is high under charging at higher current, by the characteristics that the solid electrolytes is stabilized and are not easily decomposed, etc. Further, the preparation method for manufacturing non-aqueous electrolyte lithium battery provided by the present invention is simple in process, convenient in operation, low in production cost, and easy for large-scale industrial production.

Embodiments 1 through 42 provide a method for preparing MₓNb_{y}O_{z} electrode material by solid phase method. The method is described detailed as following:

### Embodiment 1

Embodiment 1 provides a method for preparing MoNb₁₂O₃₃ electrode material by solid phase method, comprising the following steps:

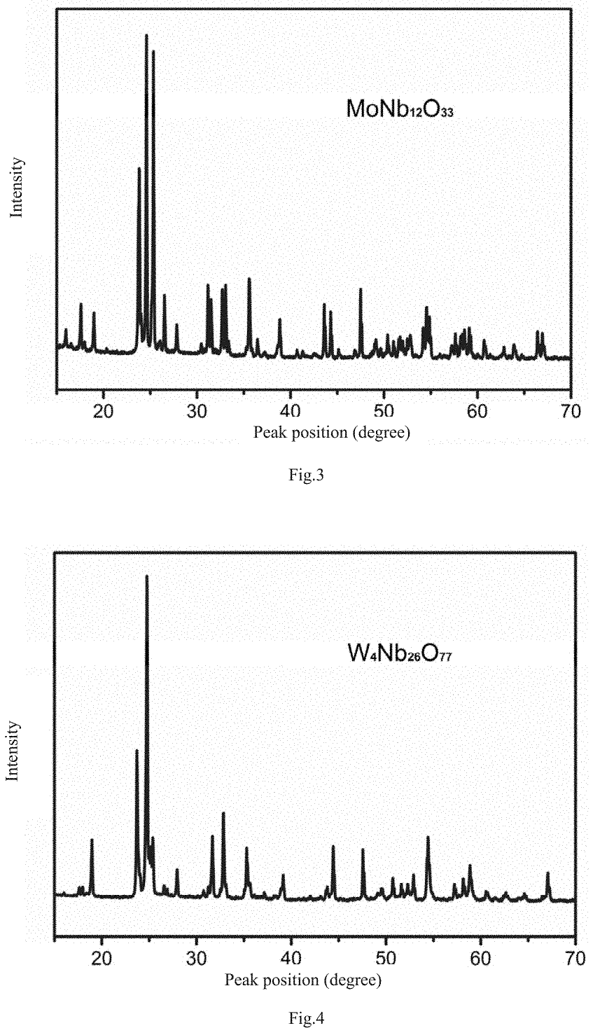

Mixing a molybdenum trioxide and a niobium pentoxide according to elements molar ratio of 1:12 by high energy ball milling; sintering the mixture at 900° C. for 12 h to obtain MoNb₁₂O₃₃ powder. As shown in FIG. 3, the MoNb₁₂O₃₃ in embodiment 1 is pure phase material, which has the shearing ReO₃ structure.

### Embodiment 2

Embodiment 2 provides a method for preparing W₄Nb₂₆O₇₇ electrode material by solid phase method, comprising the following steps:

Mixing a tungsten trioxide and a niobium pentoxide according to elements molar ratio of 4:26 by high energy ball milling; sintering the mixture at 1100° C. for 5 h to obtain W₄Nb₂₆O₇₇ powder. As shown in FIG. 4, the W₄Nb₂₆O₇₇ in embodiment 2 is pure phase material, which has the shearing ReO₃ structure.

### Embodiment 3

Embodiment 3 provides a method for preparing WNb₁₂O₃₃ electrode material by solid phase method, comprising the following steps:

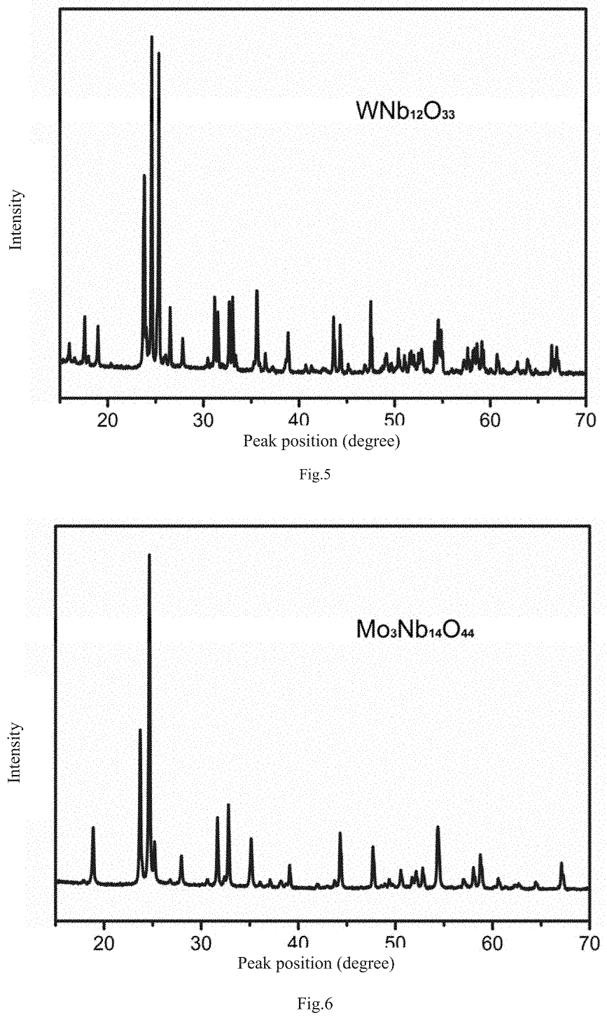

Mixing the tungsten trioxide and the niobium pentoxide according to elements molar ratio of 1:12 by high energy ball milling; sintering the mixture at 800° C. for 12 h to obtain WNb₁₂O₃₃ powder. As shown in FIG. 5, the WNb₁₂O₃₃ in embodiment 3 is pure phase material, which has the shearing ReO₃ structure.

### Embodiment 4

Embodiment 4 provides a method for preparing Mo₃Nb₁₄O₄₄ electrode material by solid phase method, comprising the following steps:

Mixing the molybdenum oxide and the niobium pentoxide according to elements molar ratio of 3:14 by high energy ball milling; sintering the mixture at 1200° C. for 4 h to obtain Mo₃Nb₄O₄₄ powder. As shown in FIG. 6, the Mo₃Nb₁₄O₄₄ in embodiment 4 is pure phase material, which has the shearing ReO₃ structure.

### Embodiment 5

Embodiment 5 provides a method for preparing W₁₈Nb₁₆O₉₄ electrode material by solid phase method, comprising the following steps:

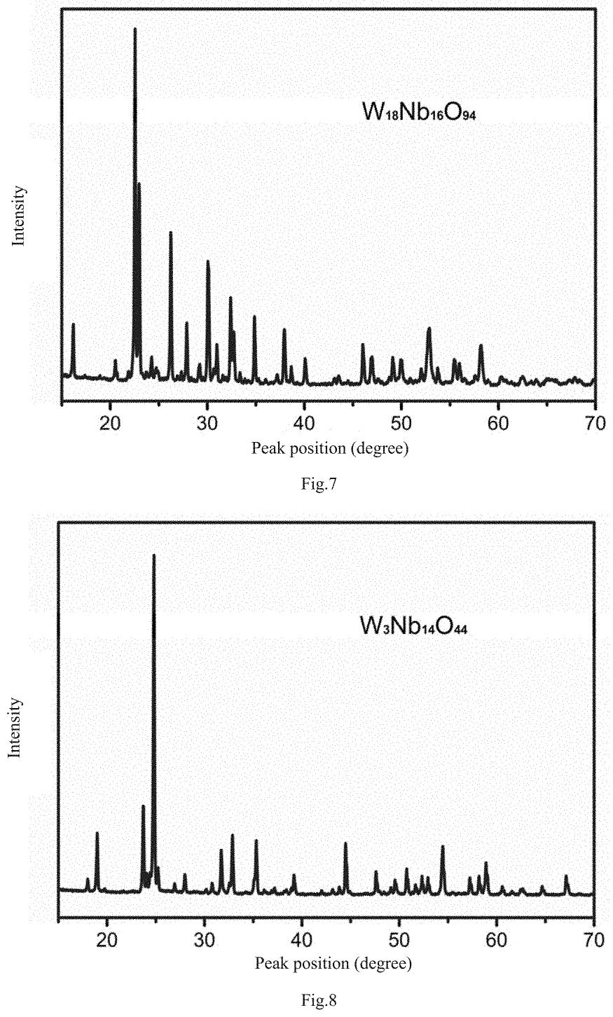

Mixing the tungsten trioxide and the niobium pentoxide according to elements molar ratio of 18:16 by high energy ball milling; sintering the mixture at 1100° C. for 8 h to obtain W₁₈Nb₁₆O₉₄ powder. As shown in FIG. 7, the W₁₈Nb₁₆O₉₄ in embodiment 5 is pure phase material, which has the shearing ReO₃ structure.

### Embodiment 6

Embodiment 6 provides a method for preparing W₃Nb₁₄O₄₄ electrode material by solid phase method, comprising the following steps:

Mixing a tungsten trioxide and a niobium pentoxide according to elements molar ratio of 3:14 by high energy ball milling; sintering the mixture at 1100° C. for 9 h to obtain W₃Nb₁₄O₄₄ powder. As shown in FIG. 8, the W₃Nb₁₄O₄₄ in embodiment 6 is pure phase material, which has a shearing ReO₃ structure.

Embodiments 7-42 of the present invention provide methods for preparing MₓNb_{y}O_{z} electrode material by solid phase method with M source and niobium source. Table 1 shows M source and niobium source, mixing ratio, sintering temperature, sintering time and final products of embodiments 7-42.

TABLE 1

| Embodi- | | | | Sintering | Sintering | |
|---|---|---|---|---|---|---|
| ment | Elements | | Niobium | temperature | time | Final |
| number | molar ratio | M source | source | (° C.) | (h) | product |
| 7 | Mo:Nb = 4:26 | molybdenum trioxide | niobium pentoxide | 1100 | 9 | Mo₄Nb₂₆O₇₇ |
| 8 | Mo:Nb = 4:26 | molybdenum trioxide | niobium oxalate | 1200 | 12 | Mo₄Nb₂₆O₇₇ |
| 9 | Mo:Nb = 4:26 | molybdenum trioxide | niobium powder | 900 | 5 | Mo₄Nb₂₆O₇₇ |
| 10 | Mo:Nb = 4:26 | molybdenum acetylacetone | niobium pentoxide | 1100 | 9 | Mo₄Nb₂₆O₇₇ |
| 11 | Mo:Nb = 4:26 | molybdenum acetylacetone | niobium oxalate | 1200 | 12 | Mo₄Nb₂₆O₇₇ |
| 12 | Mo:Nb = 4:26 | molybdenum acetylacetone | niobium powder | 900 | 8 | Mo₄Nb₂₆O₇₇ |
| 13 | V:Nb = 1:9 | vanadium pentoxide | niobium pentoxide | 1100 | 7 | VNb₉O₂₅ |
| 14 | V:Nb = 1:9 | vanadium pentoxide | niobium oxalate | 1000 | 5 | VNb₉O₂₅ |
| 15 | V:Nb = 1:9 | vanadium pentoxide | niobium powder | 900 | 5 | VNb₉O₂₅ |
| 16 | V:Nb = 1:9 | vanadium acetylacetone | niobium pentoxide | 1100 | 8 | VNb₉O₂₅ |
| 17 | V:Nb = 1:9 | vanadium acetylacetone | niobium oxalate | 1000 | 7 | VNb₉O₂₅ |
| 18 | V:Nb = 1:9 | vanadium acetylacetone | niobium powder | 900 | 5 | VNb₉O₂₅ |
| 19 | Mo:Nb = 16:18 | molybdenum trioxide | niobium pentoxide | 1100 | 8 | Mo₁₆Nb₁₈O₉₃ |
| 20 | Mo:Nb = 16:18 | molybdenum trioxide | niobium oxalate | 1000 | 5 | Mo₁₆Nb₁₈O₉₃ |
| 21 | Mo:Nb = 16:18 | molybdenum trioxide | niobium powder | 800 | 6 | Mo₁₆Nb₁₈O₉₃ |
| 22 | Mo:Nb = 16:18 | molybdenum acetylacetone | niobium pentoxide | 800 | 6 | Mo₁₆Nb₁₈O₉₃ |
| 23 | Mo:Nb = 16:18 | molybdenum acetylacetone | niobium oxalate | 1000 | 8 | Mo₁₆Nb₁₈O₉₃ |
| 24 | Mo:Nb = 16:18 | molybdenum acetylacetone | niobium powder | 1100 | 5 | Mo₁₆Nb₁₈O₉₃ |
| 25 | Cr:Nb = 9:8 | chromium trioxide | niobium pentoxide | 1000 | 5 | Cr₉Nb₁₈O₄₇ |
| 26 | Cr:Nb = 9:8 | chromium trioxide | niobium oxalate | 800 | 4 | Cr₉Nb₈O₄₇ |
| 27 | Cr:Nb = 9:8 | chromium trioxide | niobium powder | 900 | 3 | Cr₉Nb₈O₄₇ |
| 28 | Cr:Nb = 9:8 | chromium acetylacetone | niobium pentoxide | 900 | 4 | Cr₉Nb₈O₄₇ |
| 29 | Cr:Nb = 9:8 | chromium acetylacetone | niobium oxalate | 1000 | 5 | Cr₉Nb₈O₄₇ |
| 30 | Cr:Nb = 9:8 | chromium acetylacetone | niobium powder | 800 | 3 | Cr₉Nb₈O₄₇ |
| 31 | Mo:Nb = 9:8 | molybdenum trioxide | niobium pentoxide | 900 | 6 | Mo₉Nb₈O₄₇ |
| 32 | Mo:Nb = 9:8 | molybdenum trioxide | niobium oxalate | 800 | 7 | Mo₉Nb₈O₄₇ |
| 33 | Mo:Nb = 9:8 | molybdenum trioxide | niobium powder | 700 | 9 | Mo₉Nb₈O₄₇ |
| 34 | Mo:Nb = 9:8 | molybdenum acetylacetone | niobium pentoxide | 700 | 9 | Mo₉Nb₈O₄₇ |
| 35 | Mo:Nb = 9:8 | molybdenum acetylacetone | niobium oxalate | 900 | 8 | Mo₉Nb₈O₄₇ |
| 36 | Mo:Nb = 9:8 | molybdenum acetylacetone | niobium powder | 800 | 6 | Mo₉Nb₈O₄₇ |
| 37 | W:Nb = 3:2 | tungsten trioxide | niobium pentoxide | 700 | 6 | W₃Nb₂O₁₄ |
| 38 | W:Nb = 3:2 | tungsten trioxide | niobium oxalate | 900 | 8 | W₃Nb₂O₁₄ |
| 39 | W:Nb = 3:2 | tungsten trioxide | niobium powder | 1000 | 10 | W₃Nb₂O₁₄ |
| 40 | W:Nb = 3:2 | tungsten acetylacetone | niobium pentoxide | 1000 | 8 | W₃Nb₂O₁₄ |
| 41 | W:Nb = 3:2 | tungsten acetylacetone | niobium oxalate | 900 | 6 | W₃Nb₂O₁₄ |
| 42 | W:Nb = 3:2 | tungsten acetylacetone | niobium powder | 700 | 10 | W₃Nb₂O₁₄ |

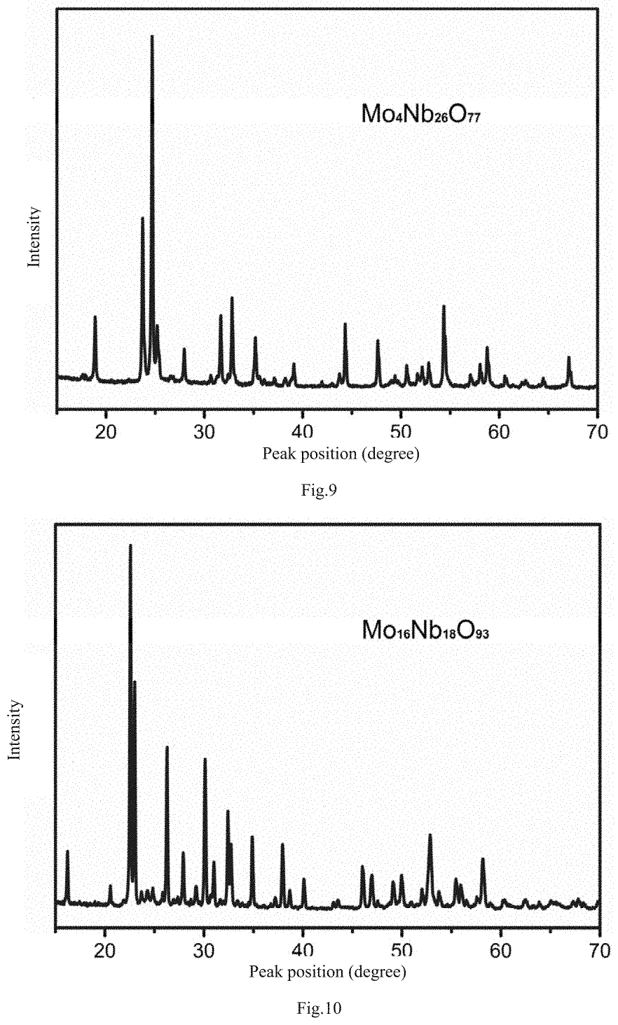

FIG. 9 shows a XRD pattern of Mo₄Nb₂₆O₇₇ produced in embodiment 7, which shows that Mo₄Nb₂₆O₇₇ material in embodiment 7 is a pure phase material, and has the shearing ReO₃ structure.

Embodiments 43-59 provide methods for preparing MₓNb_{y}O_{z} electrode material by solution method. The methods are described detailed as following:

### Embodiment 43

This embodiment provides a method for preparing W₃Nb₂O₁₄ electrode material by solution method, comprising the following steps:

S11: mixing 0.002 mol niobium ethanol, 2 ml hydrochloric acid solution with concentration of H ion ranged from 0.1 mol/L to 3 mol/L, 1 g calcium dodecylben-zenesulfonate to producing a reaction solution;

S12: mixing 0.003 mol tungsten acetylacetone with the reaction solution to producing a mixture, stirring and reacting for 4-8 h, and drying the mixture to obtain a solid product;

S13: treating the solid product at a temperature of 800-1300° C. for 4-10 h, to obtain a W₃Nb₂O₁₄ composite oxide.

### Embodiment 44

This embodiment provides a method for preparing Mo₉Nb₈O₄₇ electrode material by solution method, comprising the following steps:

S11: mixing 0.008 mol niobium ethanol, 2 ml hydrochloric acid solution with concentration of H ion ranged from 0.1 mol/L to 3 mol/L, 1 g calcium dodecylben-zenesulfonate to producing a reaction solution;

S12: mixing 0.009 mol molybdenum acetylacetone with the reaction solution to producing a mixture, stirring and reacting for 4-8 h, and drying the mixture to obtain a solid product;

S13: treating the solid product at a temperature of 800-130° C. for 4-10 h, to obtain a Mo₉Nb₈O₄₇ composite oxide.

The present invention further provided embodiments 45-59 which provide methods for preparing MₓNb_{y}O_{z} electrode material by solution method with M source and niobium source. Table 2 shows M source, niobium source, acid solution, surfactant and the ratio of them, sintering time, sintering temperature, and a final product of embodiments 45-59.

TABLE 2

| Embodi- | | | | | | sintering | sintering | |
|---|---|---|---|---|---|---|---|---|
| ments | Elements | M source | Niobium | acid | | temperature | time | final |
| number | molar ratio | (M = W, Bi) | source | solution | surfactant | (° C.) | (h) | product |
| 45 | W:Nb = 7:4 | tungsten | niobium | hydrochloric | calcium dodecylben- | 850 | 5 | W₇Nb₄O₃₁ |
| | | acetylacetone | ethanol | acid | zenesulfonate | | | |
| 46 | W:Nb = 7:4 | tungsten | niobium | acetic acid | sodium dodecyl | 800 | 4 | W₇Nb₄O₃₁ |
| | | acetylacetone | ethanol | | sulfate | | | |
| 47 | W:Nb = 7:4 | tungsten | niobium | hydrochloric | 1-hexadecylamine | 900 | 5 | W₇Nb₄O₃₁ |
| | | acetylacetone | ethanol | acid | | | | |
| 48 | W:Nb = 7:4 | tungsten | niobium | acetic acid | cetyltrimethylammonium | 850 | 5 | W₇Nb₄O₃₁ |
| | | acetylacetone | oxalate | | bromide | | | |
| 49 | W:Nb = 7:4 | tungsten | niobium | acetic acid | calcium dodecylben- | 800 | 4 | W₇Nb₄O₃₁ |
| | | acetylacetone | oxalate | | zenesulfonate | | | |
| 50 | W:Nb = 7:4 | tungsten | niobium | hydrochloric | sodium dodecyl | 800 | 5 | W₇Nb₄O₃₁ |
| | | acetylacetone | oxalate | acid | sulfate | | | |
| 51 | W:Nb = 7:4 | tungsten | niobium | hydrochloric | 1-hexadecylamine | 850 | 4 | W₇Nb₄O₃₁ |
| | | acetylacetone | oxalate | acid | | | | |
| 52 | Bi:Nb = 1:9 | bismuth | niobium | acetic acid | cetyltrimethylammonium | 850 | 4 | BiNb₉O₂₅ |
| | | acetylacetone | ethanol | | bromide | | | |
| 53 | Bi:Nb = 1:9 | bismuth | niobium | hydrochloric | calcium dodecylben- | 900 | 5 | BiNb₉O₂₅ |
| | | acetylacetone | ethanol | acid | zenesulfonate | | | |
| 54 | Bi:Nb = 1:9 | bismuth | niobium | acetic acid | sodium dodecyl | 850 | 4 | BiNb₉O₂₅ |
| | | acetylacetone | ethanol | | sulfate | | | |
| 55 | Bi:Nb = 1:9 | bismuth | niobium | hydrochloric | 1-hexadecylamine | 900 | 5 | BiNb₉O₂₅ |
| | | acetylacetone | ethanol | acid | | | | |
| 56 | Bi:Nb = 1:9 | bismuth | niobium | acetic acid | cetyltrimethylammonium | 950 | 5 | BiNb₉O₂₅ |
| | | acetylacetone | oxalate | | bromide | | | |
| 57 | Bi:Nb = 1:9 | bismuth | niobium | hydrochloric | calcium dodecylben- | 900 | 4 | BiNb₉O₂₅ |
| | | acetylacetone | oxalate | acid | zenesulfonate | | | |
| 58 | Bi:Nb = 1:9 | bismuth | niobium | hydrochloric | sodium dodecyl | 900 | 5 | BiNb₉O₂₅ |
| | | acetylacetone | oxalate | acid | sulfate | | | |
| 59 | Bi:Nb = 1:9 | bismuth | niobium | acetic acid | 1-hexadecylamine | 950 | 4 | BiNb₉O₂₅ |
| | | acetylacetone | oxalate | | | | | |

Embodiments 60-76 provide methods for preparing MₓNb_{y}O_{z} electrode material by solvent-thermal method, which is specifically described as follows:

### Embodiment 60

This embodiment provides a method for preparing MoNb₁₂O₃₃ electrode material by solvent-thermal method, comprising the following steps:

dissolving 0.001 mol molybdenum acetylacetone and 0.012 mol niobium pentachloride into 60 mL isopropanol solution, stirring the solution with magnetic force for 6 h, then adding the solution into a polytetrafluoroethylene liner of a reactor, whose capacity is 100 ml, and then heating the solution at 200° C. for 24 h to obtain a product. Washing the product with ethanol or water. Centrifugal treating and drying the product to obtain a precursor powder, then sintering the precursor powder at 680° C. for 3 h to obtain MoNb₁₂O₃₃ powder.

### Embodiment 61

This embodiment provides a method for preparing W₃Nb₁₄O₄₄ electrode material by solvent-thermal method, comprising the following steps:

dissolving 0.003 mol tungsten acetylacetone and 0.014 mol niobium pentachloride into 60 mL isopropanol solution, stirring the solution with magnetic force for 6 h, then adding the solution into the polytetrafluoroethylene liner of the reactor, whose capacity is 100 ml, and then heating the solution at 200° C. for 24 h to obtain a product. Washing the product with ethanol or water. Centrifugal treating and drying the product to obtain a precursor powder, then sintering the precursor powder at 680° C. for 3 h to obtain W₃Nb₁₄O₄₄ powder.

The present invention further provided embodiments 62-79 which provide methods for preparing MₓNb_{y}O_{z} electrode material by solvent-thermal method with M source and niobium source. Table 3 shows M source, niobium source, organic solvent, and mixing ratio of them, sintering time, sintering temperature, and final products of embodiments 62-79.

TABLE 3

| Embodi- | | | | | sintering | sintering | |
|---|---|---|---|---|---|---|---|
| ment | Molar ration | M source | | Organic | temperature | time | final |
| number | of elements | (M = W, Mo) | Nb source | solvent | (° C.) | (h) | product |
| 62 | Mo:Nb = 9:8 | molybdenum tetrachloride | niobium ethoxide | N,N-DIMETHYL- | 700 | 3 | Mo₉Nb₈O₄₇ |
| | | | | FORMAMIDE | | | |
| 63 | Mo:Nb = 9:8 | molybdenum tetrachloride | niobium oxalate | ethanol | 650 | 4 | Mo₉Nb₈O₄₇ |
| 64 | Mo:Nb = 9:8 | molybdenum tetrachloride | niobium powder | N,N-DIMETHYL- | 680 | 3 | Mo₉Nb₈O₄₇ |
| | | | | FORMAMIDE | | | |
| 65 | Mo:Nb = 9:8 | molybdenum acetylacetone | niobium ethoxide | ethanol | 650 | 4 | Mo₉Nb₈O₄₇ |
| 66 | Mo:Nb = 9:8 | molybdenum acetylacetone | niobium oxalate | N,N-DIMETHYL- | 700 | 5 | Mo₉Nb₈O₄₇ |
| | | | | FORMAMIDE | | | |
| 67 | Mo:Nb = 9:8 | molybdenum acetylacetone | niobium powder | ethanol | 680 | 3 | Mo₉Nb₈O₄₇ |
| 68 | W:Nb = 9:8 | tungsten acetate | niobium ethoxide | N,N-DIMETHYL- | 650 | 3 | W₉Nb₈O₄₇ |
| | | | | FORMAMIDE | | | |
| 69 | W:Nb = 9:8 | tungsten acetate | niobium oxalate | ethanol | 700 | 5 | W₉Nb₈O₄₇ |
| 70 | W:Nb = 9:8 | tungsten acetate | niobium powder | N,N-DIMETHYL- | 700 | 4 | W₉Nb₈O₄₇ |
| | | | | FORMAMIDE | | | |
| 71 | W:Nb = 9:8 | tungsten chloride | niobium ethoxide | N,N-DIMETHYL- | 650 | 5 | W₉Nb₈O₄₇ |
| | | | | FORMAMIDE | | | |
| 72 | W:Nb = 9:8 | tungsten chloride | niobium oxalate | ethanol | 750 | 4 | W₉Nb₈O₄₇ |
| 73 | W:Nb = 9:8 | tungsten chloride | niobium powder | N,N-DIMETHYL- | 600 | 3 | W₉Nb₈O₄₇ |
| | | | | FORMAMIDE | | | |
| 74 | Mo:Nb = 16:18 | molybdenum acetylacetone | niobium ethoxide | ethanol | 650 | 4 | Mo₁₆Nb₁₈O₉₃ |
| 75 | Mo:Nb = 16:18 | molybdenum acetylacetone | niobium oxalate | N,N-DIMETHYL- | 700 | 5 | Mo₁₆Nb₁₈O₉₃ |
| | | | | FORMAMIDE | | | |
| 76 | Mo:Nb = 16:18 | molybdenum acetylacetone | niobium powder | ethanol | 750 | 3 | Mo₁₆Nb₁₈O₉₃ |
| 77 | Mo:Nb = 16:18 | molybdenum acetate | niobium ethoxide | N,N-DIMETHYL- | 650 | 3 | Mo₁₆Nb₁₈O₉₃ |
| | | | | FORMAMIDE | | | |
| 78 | Mo:Nb = 16:18 | molybdenum acetate | niobium oxalate | ethanol | 600 | 5 | Mo₁₆Nb₁₈O₉₃ |
| 79 | Mo:Nb = 16:18 | molybdenum acetate | niobium powder | N,N-DIMETHYL- | 700 | 4 | Mo₁₆Nb₁₈O₉₃ |
| | | | | FORMAMIDE | | | |

Electrochemical properties of MₓNb_{y}O_{z} electrode material manufactured by different methods are measured in embodiments 80-83, specifically described as following:

### Embodiment 80

This embodiment provides a non-aqueous electrolyte ion half-cell manufactured by solid phase method, specifically, a non-aqueous electrolyte ion half-cell is manufactured by using MoNb₁₂O₃₃ material produced by solid phase method in embodiment 1 as a positive active material, Li plate as a negative electrode, using a polyethylene diaphragm, using a lithium hexafluorophosphate as electrolyte salt.

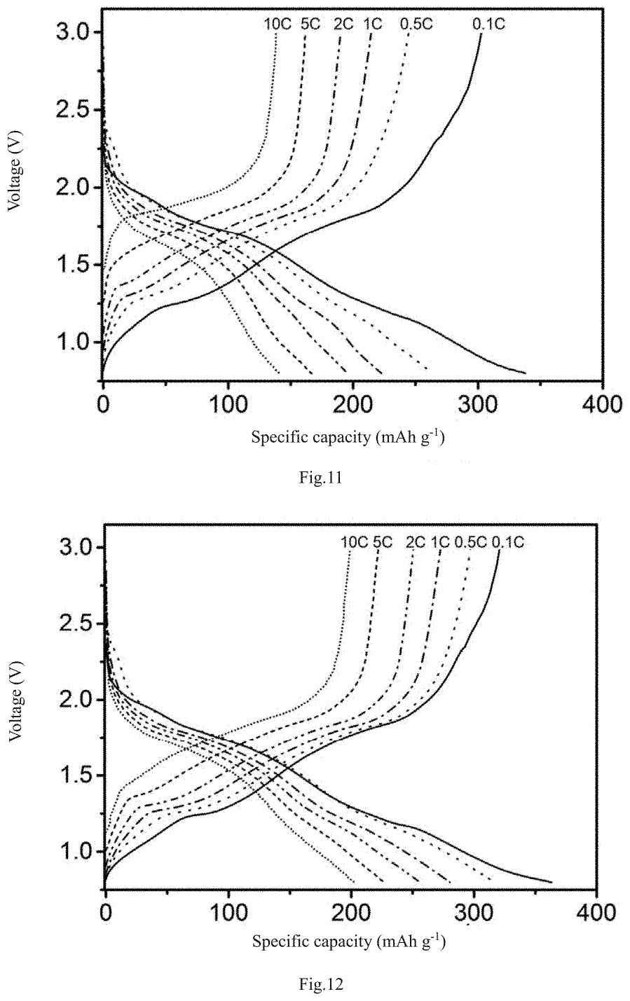

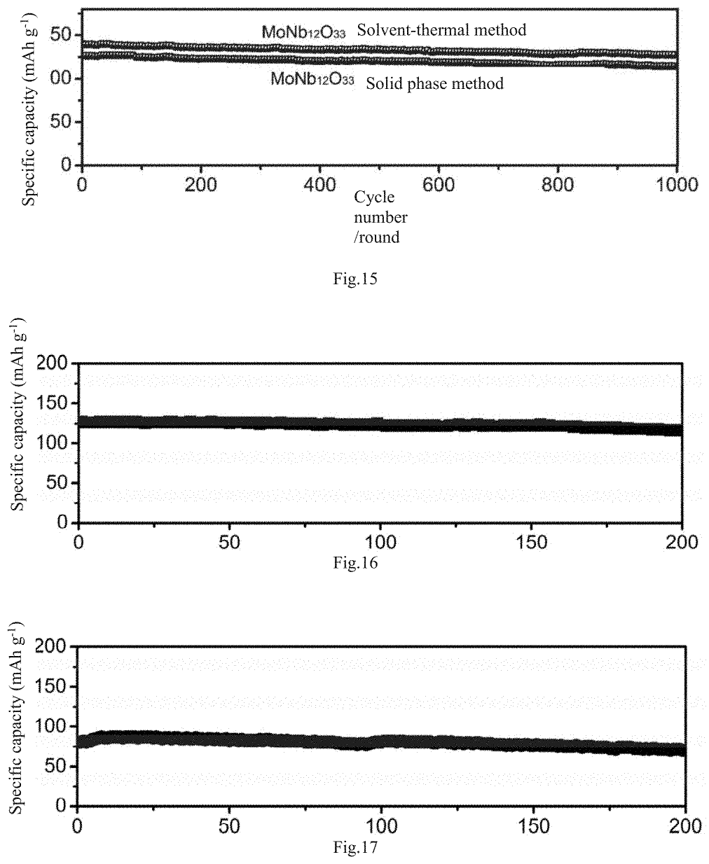

The nonaqueous electrolyte lithium ion half-cell is subjected to repeated charge-discharge cycle test at a voltage range from 0.8V to 3V. As shown in FIG. 11, the initial discharge capacity reached to 340 mAh/g, and as shown in FIG. 15, 1000 stable cycles can be repeated at a current density of 10 C.

### Embodiments 81

This embodiment provides a non-aqueous electrolyte ion half-cell manufactured by solvent-thermal method, specifically, a non-aqueous electrolyte ion half-cell is manufactured by using MoNb₁₂O₃₃ material produced by solvent-thermal method in embodiment 60 as a positive active material, Li plate as a negative electrode, using a polyethylene diaphragm, using a lithium hexafluorophosphate as electrolyte salt.

The non-aqueous electrolyte lithium ion half-cell is subjected to repeated charge-discharge cycle test at a voltage range from 0.8V to 3V. As shown in FIG. 12, the initial discharge capacity reached to 362 mAh/g, and as shown in FIG. 15, 1000 stable cycles can be repeated at the current density of 10 C.

### Embodiments 82

This embodiment provides a non-aqueous electrolyte ion half-cell manufactured by solid phase method, specifically, a non-aqueous electrolyte ion half-cell is manufactured by using W₃Nb₁₄O₄₄ material produced by solid phase method in embodiment 2 as a positive active material, Li plate as a negative electrode, using a polyethylene diaphragm, using a lithium hexafluorophosphate as electrolyte salt.

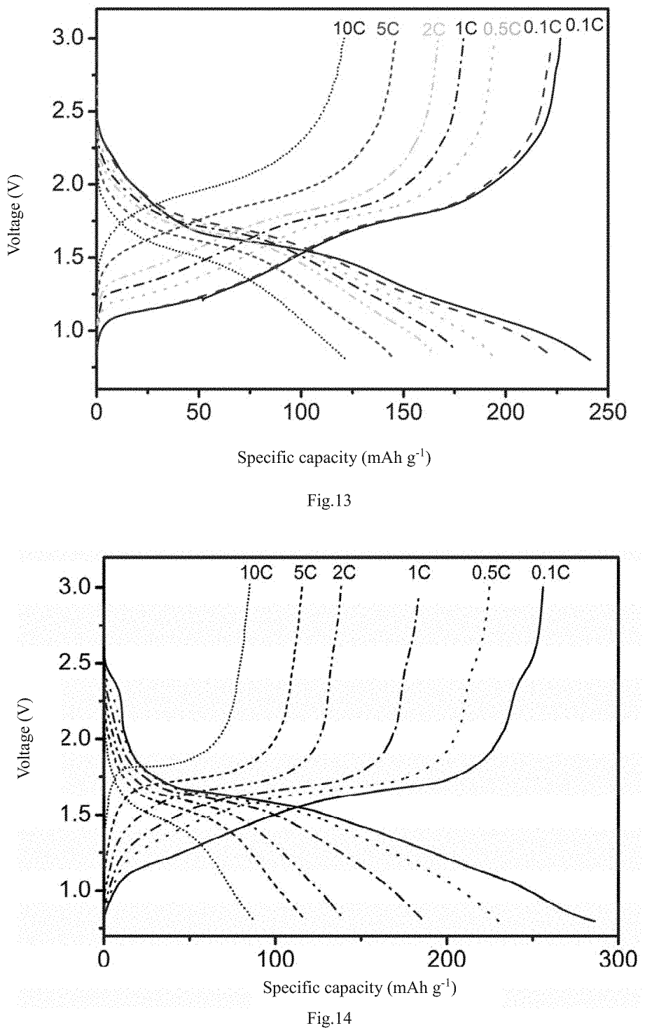

The non-aqueous electrolyte lithium ion half-cell is subjected to repeated charge-discharge cycle test at a voltage range from 0.8V to 3V. As shown in FIG. 13, the initial discharge capacity reached to 242 mAh/g, and as shown in FIG. 16, 200 stable cycles can be repeated at the current density of 10 C.

### Embodiments 83

This embodiment provides a non-aqueous electrolyte ion half-cell manufactured by solution method, specifically, a non-aqueous electrolyte ion half-cell is manufactured by using W₃Nb₂O₁₄ material produced by solution method in embodiment 43 as a positive active material, Li plate as a negative electrode, using a polyethylene diaphragm, using a lithium hexafluorophosphate as electrolyte salt.

The non-aqueous electrolyte lithium ion half-cell is subjected to repeated charge-discharge cycle test at a voltage range from 0.8V to 3V. As shown in FIG. 14, the initial discharge capacity reached to 278 mAh/g, and as shown in FIG. 17, 200 stable cycles can be repeated at the current density of 10 C.

Embodiments 84-93 provide a method for manufacturing the solid state non-aqueous electrolyte lithium-ion battery with MₓNb_{y}O_{z} used as anode material comprises the following steps:

dissolving a solid state non-aqueous electrolyte into an organic solvent to obtain a gel liquid;

mixing a positive electrode material, an electric conductive agent, and the gel liquid uniformly to form a mixture, and then, coating the mixture onto a positive current collector, and then soliding to obtain a positive electrode solid material; rolling the positive electrode solid material and depositing a LiNbO₃ layer with a thickness thereof is 5-30 nm to obtain a positive electrode plate;

mixing a negative electrode material, the electric conductive agent, and the gel liquid uniformly to form a mixture, and then, coating the mixture onto a negative current collector, and then soliding to obtain a negative solid material; balling the solid state non-aqueous electrolyte, and then dissolving the balled solid state non-aqueous electrolyte into the organic solvent to obtain a slurry, coating the slurry on the negative solid material to form a diaphragm, and then rolling and soliding to obtain a negative electrode plate;

assembling the positive electrode plate and the negative electrode plate by laminating technology, to prepare the solid state non-aqueous electrolyte lithium-ion battery.

In the sulfide based solid state non-aqueous electrolyte battery, the LiNbO₃ covers the positive electrode oxide active material. The LiNbO₃ is deposited as single atom layer.

Preferably, a soliding temperature for the positive electrode plate is ranged from 60° C. to 150° C., and the time is ranged from 2 h to 11 h; the soliding temperature for the negative solid material and the negative electrode plate is ranged from 70 C to 160 C, and the time is ranged from 2 h to 14 h.

Preferably, 65%-85% by mass weight of the positive electrode material, 2%-5% by mass weight of the electric conductive agent, 10%-33% by mass weight of the solid non-aqueous electrolyte, based on a total mass weight of the positive electrode plate; 65%-85% by mass weight of the negative electrode material, 2%-5% by mass weight of the electric conductive agent, 10%-33% by mass weight of the solid non-aqueous electrolyte, based on a total mass weight of the negative electrode plate.

The laminating technology is operated at room temperature, and a pressure applied onto laminating plates is ranged from 300 MPa to 600 MPa.

### Embodiment 84

The solid battery is prepared by using WNb₁₂O₃₃ material produced by solution method as the negative active material, using LiMn₂O₄ as positive active material, using Li_{9.54}Si_{1.74}P_{1.44}S_{11.7}Cl_{0.3} as the solid electrolyte.

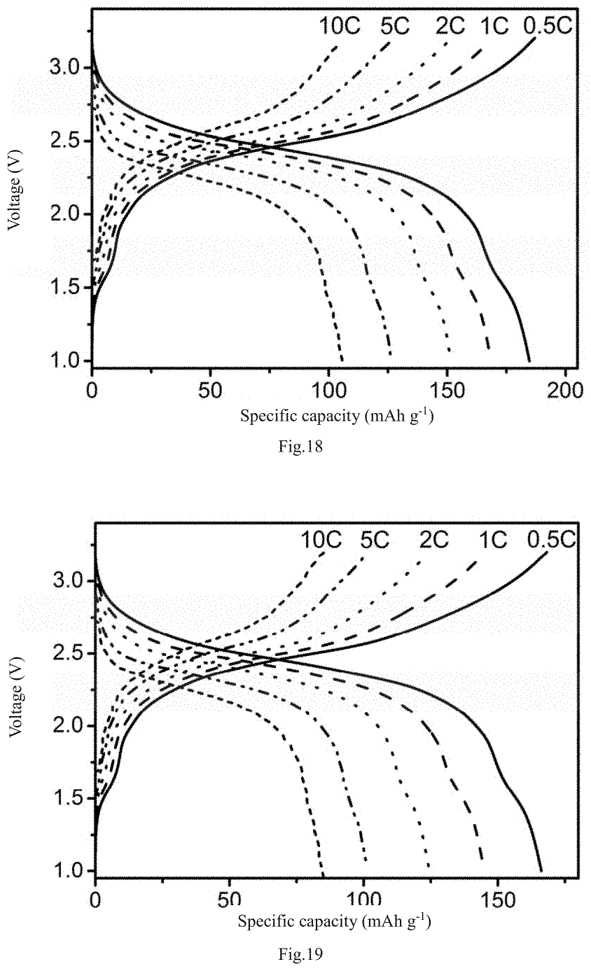

The solid battery is subjected to repeated charge-discharge cycle tests at a voltage range from 1V to 3.2V. As shown in FIG. 18, the initial discharge capacity of WNb₁₂O₃₃/LiMn₂O₄ solid state battery reached to 185 mAh/g, and as shown in FIG. 21, 80 stable cycles can be repeated.

### Embodiment 85

The solid battery is prepared by using Mo₃Nb₁₄O₄₄ material produced by solid phase method as the negative active material, using LiMn₂O₄ as positive active material, using Li_{9.54}Si_{1.74}P_{1.44}S_{11.7}Cl_{0.3} as the solid electrolyte.

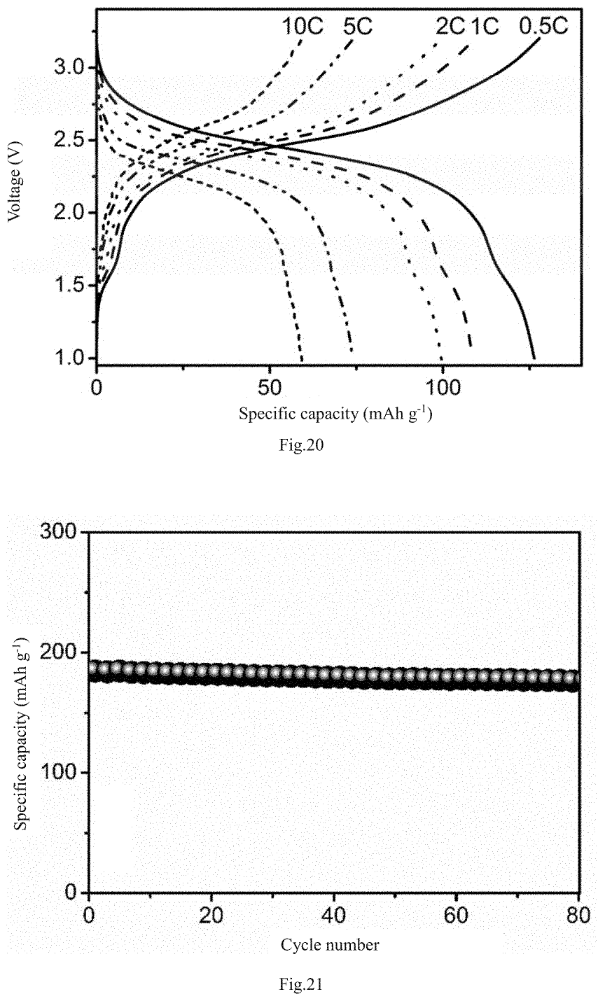

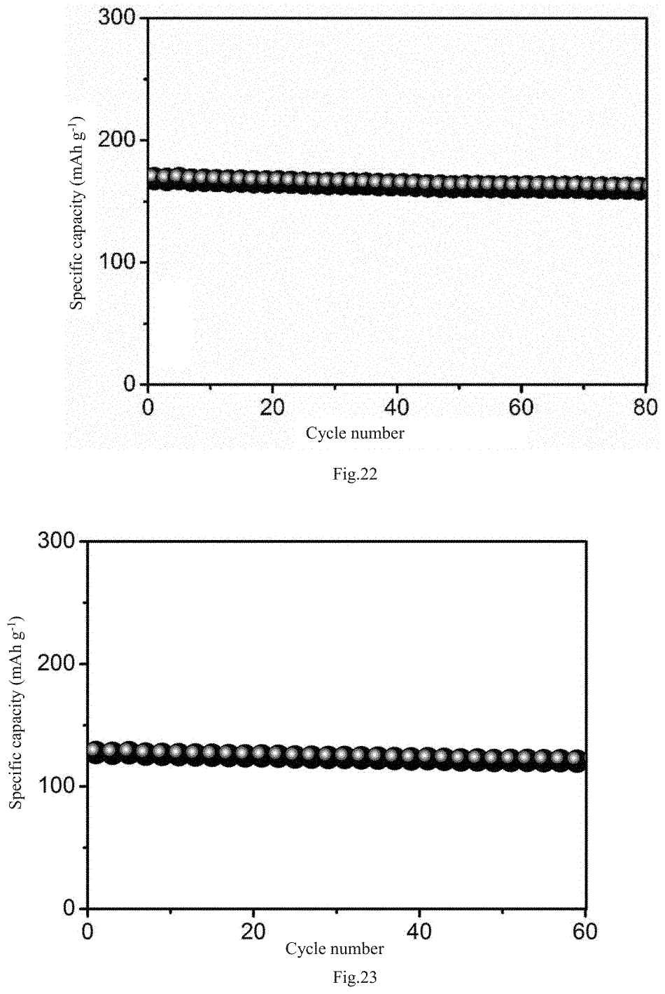

The solid battery is subjected to repeated charge-discharge cycle tests at a voltage range from 1V to 3.2V. As shown in FIG. 19, the initial discharge capacity of Mo₃Nb₁₄O₄₄/LiMn₂O₄ solid state battery reached to 168 mAh/g, and as shown in FIG. 22, 80 stable cycles can be repeated.

### Embodiment 86

The solid battery is prepared by using W₄Nb₂₆O₇₇ material produced by solvent-thermal method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. As shown in FIG. 20, the initial discharge capacity of W₄Nb₂₆O₇₇/LiMn₂O₄ solid state battery reached to 127 mAh/g, and as shown in FIG. 23, 60 stable cycles can be repeated.

### Embodiment 87

The solid battery is prepared by using W₉Nb₈O₄₇ material produced by solid phase method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of W₉Nb₈O₄₇/LiMn₂O₄ solid state battery reached to 113 mAh/g, and 40 stable cycles can be repeated.

### Embodiment 88

The solid battery is prepared by using MoNb₁₂O₃₃ material produced by solution method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of W₉Nb₈O₄₇/LiMn₂O₄ solid state battery reached to 108 mAh/g, and 50 stable cycles can be repeated.

### Embodiment 89

The solid battery is prepared by using BiNb₉O₂₅ material produced by solid phase method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of BiNb₉O₂₅/LiMn₂O₄ solid state battery reached to 99 mAh/g, and 70 stable cycles can be repeated.

### Embodiment 90

The solid battery is prepared by using Cr₃Nb₂O₁₄ material produced by solid phase method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of BiNb₉O₂₅/LiMn₂O₄ solid state battery reached to 76 mAh/g, and 55 stable cycles can be repeated.

### Embodiment 91

The solid battery is prepared by using Mn₇Nb₄O₃₁ material produced by solid phase method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of BiNb₉O₂₅/LiMn₂O₄ solid state battery reached to 67 mAh/g, and 40 stable cycles can be repeated.

### Embodiment 92

The solid battery is prepared by using FeNb₁₂O₃₃ material produced by solid phase method as the negative active material, using LiMn₂O₄ as positive active material, using Li₃PS₄ as the solid electrolyte.

The solid battery is subjected to repeated charge-discharge cycle tests at a voltage range from 1V to 3.2V. The initial discharge capacity of FeNb₁₂O₃₃/LiMn₂O₄ solid state battery reached to 54 mAh/g, and 30 stable cycles can be repeated.

### Embodiment 93

The solid battery is prepared by using VNb₉O₂₅ material produced by solid phase method as the negative active material, using LiMn₂O₄ as positive active material, using Li_{9.54}Si_{1.74}P_{1.44}S_{11.7}Cl_{0.3} as the solid electrolyte.

The solid battery is subjected to repeated charge-discharge cycle tests at a voltage range from 1V to 3.2V. The initial discharge capacity of VNb₉O₂₅/LiMn₂O₄ solid state battery reached to 130 mAh/g, and 60 stable cycles can be repeated.

The above is only the embodiment of the present disclosure, but not limit to the patent scope of the present disclosure, and equivalent structures or equivalent process transformations made by utilizing the present disclosure and the contents of the drawings, or directly or indirectly applied to other related technical fields, are all included in the scope of the patent protection of the present disclosure.

What is claimed is:

1. An anode material, comprising: a chemical formula of the anode material of the lithium-ion battery is MₓNb_{y}O_{z}, wherein, M is a pentavalent non-niobium metal ion or a hexavalent non-niobium metal ion, and x, y, z satisfy the following conditions: 1<x≤16, 2≤y≤28, and 13≤z≤94.

2. The anode material of a lithium-ion battery according to claim 1, wherein, MₓNb_{y}O_{z} may be one or more compounds selected from MNb₉O₂₅, M₃Nb₁₄O₄₄, MNb₁₂O₃₃, M₄Nb₂₆O₇₇, M₅Nb₁₆O₅₅, MsNb₁₈O₆₉, MNb₄O₁₃, M₁₆Nb₁₈O₉₃, M₇Nb₄O₃₁ and M₉Nb₈O₄₇.

3. The anode material of a lithium-ion battery according to claim 1, wherein, M is one or more elements selected from V, Bi, W, Mo, Cr, Mn and Fe.

4. The anode material of a lithium-ion battery according to claim 2, wherein, M is one or more elements selected from V, Bi, W, Mo, Cr, Mn and Fe.

5. The anode material of a lithium-ion battery according to claim 1, wherein, a crystal structure of MₓNb_{y}O_{z} comprises a shearing ReO₃ structure and a tungsten bronze structure.

6. The anode material of a lithium-ion battery according to claim 2, wherein, a crystal structure of MₓNb_{y}O_{z} comprises a shearing ReO₃ structure and a tungsten bronze structure.

7. The anode material of a lithium-ion battery according to claim 1, wherein, the MₓNb_{y}O_{z} is composed of by one or more structure units selected from MeO₆ octahedral structure unit and MeO₄ tetrahedral structure unit, Me comprises Nb ion and/or non-niobium metal ion.

8. The anode material of a lithium-ion battery according to claim 7, wherein, the structure of MₓNb_{Y}O_{z} is made by the octahedral structure unit and/or the tetrahedral structure unit connected with each other in one or more connection methods selected from the group of common dot connection, common edge connection and common surface connection.

9. The anode material of a lithium-ion battery according to claim 1, wherein, the structure of MₓNb_{y}O_{z} is made by the octahedral structure unit and/or the tetrahedral structure unit connected with each other in one or more connection methods selected from the group of common dot connection, common edge connection and common surface connection.

10. The anode material of a lithium-ion battery according to claim 1, wherein, MₓNb_{y}O_{z} is one or more compounds selected from a group of W₃Nb₁₄O₄₄, WNb₁₂O₃₃, W₄Nb₂₆O₇₇, W₅Nb₁₆O₅₅, W₈Nb₁₈O₆₉, WNb₄O₁₃, W₁₆Nb₁₈O₉₃, W₇Nb₄O₃₁, W₉Nb₈O₄₇, Mo₃Nb₁₄O₄₄, MoNb₁₂O₃₃, Mo₄Nb₂₆O₇₇, Mo₅Nb₁₆O₅₅, MoNb₁₈O₆₉, MoNb₄O₁₃, Mo₁₆Nb₁₈O₉₃, Mo₇Nb₄O₃₁, Mo₉Nb₈O₄₇, Cr₃Nb₁₄O₄₄, CrNb₁₂O₃₃, Cr₄Nb₂₆O₇₇, Cr₅Nb₆O₅₅, Cr₈Nb₁₈O₆₉, CrNb₄O₁₃, Mo₁₆Nb₁₈O₉₃, Cr₇Nb₄O₃₁, Cr₉Nb₈O₄₇, VNb₉O₂₅ and BiNb₉O₂₅.

11. A non-aqueous electrolyte lithium-ion battery, comprising: a positive electrode material, non-aqueous electrolyte, and an anode material according to claim 1.

12. The non-aqueous electrolyte lithium-ion battery according to claim 11 comprising one or more type of a liquid state non-aqueous electrolyte lithium-ion battery, a gel state non-aqueous electrolyte lithium-ion battery, and a solid state non-aqueous electrolyte lithium-ion battery.

13. The non-aqueous electrolyte lithium-ion battery according to claim 12, wherein, the solid state non-aqueous electrolyte comprises a sulfide based solid state electrolyte and/or an oxide-based solid state electrolyte;
the sulfide based solid state electrolyte comprising Li₂S-A, halogen doped Li₂S-A, Li₂S-MeS₂—P₂S₅ or halogen doped Li₂S-MeS₂—P₂S₅, wherein, A is one or more compounds selected from P₂S₅, SiS₂, GeS₂, B₂S₃ and Al₂S₄, Me is one or more elements selected from Si, Ge, Sn and Al, halogen is one or more elements selected from Cl, Br and I.

14. A method for manufacturing the solid state non-aqueous electrolyte lithium-ion battery according to claim 12 comprising the following steps:
dissolving a solid state non-aqueous electrolyte into an organic solvent to obtain a gel liquid;
mixing a positive electrode material, an electric conductive agent, and the gel liquid uniformly to form a mixture, and then, coating the mixture onto a positive current collector, and then soliding to obtain a positive electrode plate;
mixing a negative electrode material, the electric conductive agent, and the gel liquid uniformly to form a mixture, and then, coating the mixture onto a negative current collector, and then soliding to obtain a negative solid material;
balling the solid state non-aqueous electrolyte, and then dissolving the balled solid state non-aqueous electrolyte into the organic solvent to obtain a slurry, coating the slurry on the negative solid material to form a diaphragm, and then rolling and soliding to obtain a negative electrode plate;
assembling the positive electrode plate and the negative electrode plate by laminating technology, to prepare the solid state non-aqueous electrolyte lithium-ion battery.

15. The method for manufacturing the solid state non-aqueous electrolyte lithium-ion battery according to claim 14, wherein, a soliding temperature for the positive electrode plate is ranged from 60° C. to 150 C, and the time is ranged from 2 h to 11 h;
the soliding temperature for the negative solid material and the negative electrode plate is ranged from 70° C. to 160° C., and the time is ranged from 2 h to 14 h.

16. The method for manufacturing the solid state non-aqueous electrolyte lithium-ion battery according to claim 14, wherein, the solid state non-aqueous electrolyte lithium-ion battery comprises:
65%-85% by mass weight of the positive electrode material, 2%-5% by mass weight of the electric conductive agent, 10%-33% by mass weight of the solid non-aqueous electrolyte, based on a total mass weight of the positive electrode plate;
65%-85% by mass weight of the negative electrode material, 2%-5% by mass weight of the electric conductive agent, 10%-33% by mass weight of the solid non-aqueous electrolyte, based on a total mass weight of the negative electrode plate.

17. The method for manufacturing the solid state non-aqueous electrolyte lithium-ion battery according to claim 14, wherein, the laminating technology is operated at room temperature, and a pressure applied onto laminating plates is ranged from 300 MPa to 600 MPa.

18. A method for manufacturing the solid state non-aqueous electrolyte lithium-ion battery according to claim 12, wherein, comprises the steps:
mixing the anode material, a solid state electrolyte, and a conductive carbon black at a mass weight ratio of 60:35:5 to form an anode mixture powder;
mixing the positive electrode material, the solid state electrolyte, and the conductive carbon black at a mass weight ratio of 60:35:5 to form an positive electrode mixture powder;
the positive electrode mixture powder, the solid state electrolyte, and the anode mixture powder arranged as layers in orderly, rolling to form a sandwiched structure;
connecting the positive electrode and the anode of the sandwiched structure with the current collector to form the solid state lithium-ion battery.
